(19) United States
(12) Patent Application Publication
(10) Pub. No.: US 2025/0303869 A1
(43) Pub. Date: Oct. 2, 2025

(54) IN-VEHICLE SYSTEM

(71) Applicant: TOYOTA JIDOSHA KABUSHIKI KAISHA, Toyota-shi (JP)

(72) Inventor: Hiroshi HIRANO, Toyota-shi (JP)

(73) Assignee: TOYOTA JIDOSHA KABUSHIKI KAISHA, Toyota-shi (JP)

(21) Appl. No.: 19/002,976

(22) Filed: Dec. 27, 2024

(30) Foreign Application Priority Data
Mar. 28, 2024 (JP) 2024-054644

(51) Int. Cl. B60L 1/00; B60L 58/10

(52) U.S. Cl. CPC B60L 1/00; B60L 58/10

(57) ABSTRACT

The second electronic control unit identifies, as the specific buffer set, a buffer set having a voltage value included in the non-buffer set among the voltage values included in the time-sequence data of the buffer set stored in the ring buffer. The second electronic control unit specifies the current value included in the specific buffer set as the current value detected at the same time as the current value included in the non-buffer set.

### CROSS-REFERENCE TO RELATED APPLICATION

This application claims priority to Japanese Patent Application No. 2024-054644 filed on Mar. 28, 2024, incorporated herein by reference in its entirety.

### BACKGROUND

### 1. Technical Field

The disclosure relates to an in-vehicle system.

### 2. Description of Related Art

An in-vehicle system described in Japanese Unexamined Patent Application Publication No. 2005-201144 (JP 2005-201144 A) includes an electronic control unit, a first transmitting unit that transmits first time-dependent data including time data to the electronic control unit, and a second transmitting unit that transmits second time-dependent data including time data to the electronic control unit. The electronic control unit ensures synchronicity of the two pieces of time-dependent data by comparing the time data included in the first time-dependent data with the time data included in the second time-dependent data.

### SUMMARY

However, with in-vehicle systems such as described in JP 2005-201144 A, there are situations in which the time information transmitted by the first transmitting device and the time information transmitted by the second transmitting device are not synchronized. In this case, there is concern that the synchronicity cannot be ensured even when the electronic control unit compares the two pieces of time information.

In order to solve the above problem, the disclosure is an in-vehicle system, including an auxiliary battery that supplies electric power to auxiliary equipment of a vehicle, a first voltage sensor that detects a voltage value of the auxiliary battery as a first voltage value,
a first current sensor that detects a current value of the auxiliary battery, when detecting the first voltage value, as a first current value,
a second voltage sensor that detects a voltage value of the auxiliary battery as a second voltage value,
a second current sensor that detects a current value of the auxiliary battery, when detecting the second voltage value, as a second current value,
a first electronic control unit that acquires the first voltage value from the first voltage sensor, and also acquires the first current value from the first current sensor, and
a second electronic control unit that includes a ring buffer, and that acquires the second voltage value from the second voltage sensor, and also acquires the second current value from the second current sensor, in which
the first electronic control unit executes transmitting of the first voltage value and the first current value to the second electronic control unit, and
the second electronic control unit executes
receiving the first voltage value and the first current value from the first electronic control unit,
storing, in the ring buffer, time-sequence data of a stipulated period set in advance, of one of a first set that is a combination of the first voltage value and the first current value and a second set that is a combination of the second voltage value and the second current value, as time-sequence data of a buffer set, and
identifying a current value included in the buffer set with a voltage value nearest to a voltage value included in a non-buffer set that is a set differing from the buffer set out of the first set and the second set, of the voltage values included in the time-sequence data in the buffer set, as a current value detected at the same time as the current value included in the non-buffer set.

According to the above configuration, even when the time information in which the first current value is detected and the time information in which the second current value is detected are not synchronized, loss of synchronicity of the combination of the first current value and the second current value can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an in-vehicle system;

FIG. 2 is a flowchart illustrating a series of processes including a first set of transmissions;

FIG. 3 is a flow chart illustrating a series of processes including generation of a second set; and

FIG. 4 is a flowchart illustrating a series of processes including calculation of a resistance value of an auxiliary battery.

### DETAILED DESCRIPTION OF EMBODIMENTS

### Embodiment

### Outline of In-Vehicle System

Hereinafter, an embodiment of an in-vehicle system will be described with reference to the drawings.

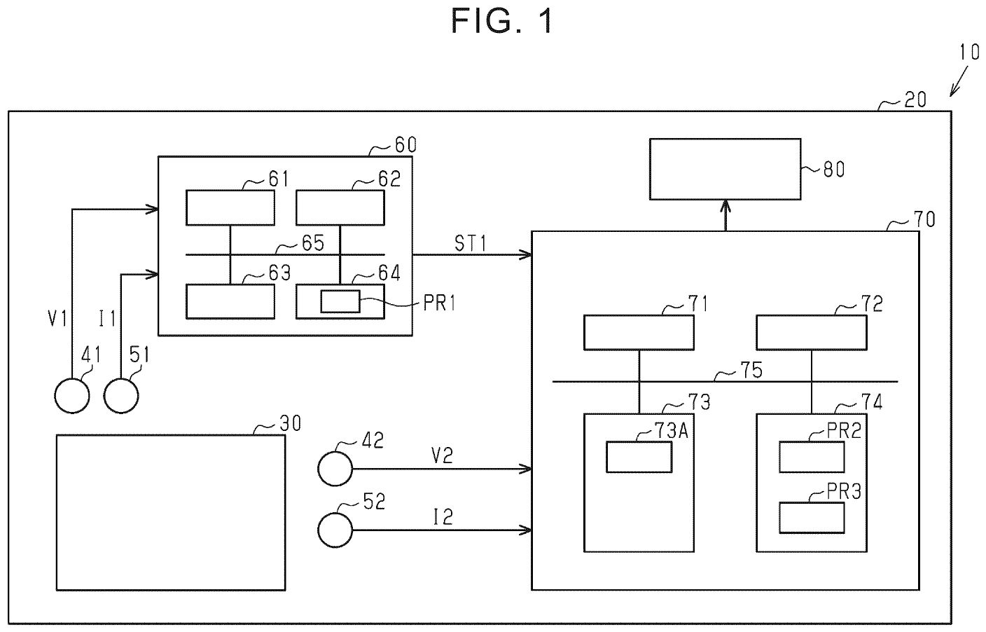

As illustrated in FIG. 1, the vehicle 10 includes an in-vehicle system 20. The in-vehicle system 20 includes an auxiliary battery 30, a first voltage sensor 41, a second voltage sensor 42, a first current sensor 51, and a second current sensor 52.

The auxiliary battery 30 supplies electric power to the auxiliary equipment of the vehicle 10. The auxiliary battery 30 is a secondary battery. The auxiliary battery 30 is, for example, a lithium-ion battery. The auxiliary equipment of the vehicle 10 is, for example, an electric oil pump, a navigation system, or a lamp.

The first voltage sensor 41 detects the voltage value of the output voltage of the auxiliary battery 30 as the first voltage value V1. The second voltage sensor 42 detects the voltage value of the output voltage of the auxiliary battery 30 as the second voltage value V2. The second voltage sensor 42 detects the second voltage value V2 at the same detection location as the detection location of the first voltage value V1 of the first voltage sensor 41. The detection period of the first voltage sensor 41 is the same as the detection period of the second voltage sensor 42.

The first current sensor 51 detects the current value flowing through the auxiliary battery 30 when the first voltage value V1 is detected as the first current value I1. The first current sensor 51 detects a current value at the time of discharging as a positive value and a current value at the time of charging as a negative value.

The second current sensor 52 detects the current value flowing through the auxiliary battery 30 when the second voltage value V2 is detected as the second current value 12. The second current sensor 52 detects the current value at the time of discharging as a positive value and the current value at the time of charging as a negative value. The detection period of the first current sensor 51 is the same as the detection period of the second current sensor 52.

The in-vehicle system 20 includes a first electronic control unit 60, a second electronic control unit 70, and a notification device 80. The first electronic control unit 60 and the second electronic control unit 70 can communicate with each other via a network such as a controller area network (CAN).

The first electronic control unit 60 acquires the first voltage value V1 from the first voltage sensor 41. The first electronic control unit 60 acquires the first current value I1 from the first current sensor 51. The first electronic control unit 60 includes a central processing unit (CPU) 61, peripheral circuit 62, a random access memory (RAM) 63, a storage device 64, and a bus 65. The bus 65 communicatively connects CPU 61, the peripheral circuit 62, RAM 63, and the storage device 64 to each other. CPU 61 performs information processing by executing various programs stored in the storage device 64. The peripheral circuit 62 includes a circuit that generates time information, a circuit that generates a clock signal that defines an internal operation, a power supply circuit, a reset circuit, and the like. RAM 63 stores data generated as CPU 61 operates. The storage device 64 stores transmission program PRI of the first-set ST1 to be executed by CPU 61.

The second electronic control unit 70 acquires the second voltage value V2 from the second voltage sensor 42. The second electronic control unit 70 acquires the second current value I2 from the second current sensor 52. The second electronic control unit 70 receives a first set ST1 including a first voltage value V1 and a first current value I1 from the first electronic control unit 60.

The second electronic control unit 70 includes a CPU 71, peripheral circuit 72, a RAM 73, a storage device 74, and a bus 75. The bus 75 communicatively connects CPU 71, the peripheral circuit 72, RAM 73, and the storage device 74 to each other.

CPU 71 performs information processing by executing various programs stored in the storage device 74. The peripheral circuit 72 includes a circuit that generates time information, a circuit that generates a clock signal that defines an internal operation, a power supply circuit, a reset circuit, and the like. In the present embodiment, the time information generated by the peripheral circuit 72 is not synchronized with the time information generated by the peripheral circuit 62. The storage device 74 stores a storage program PR2 of the buffer set STB executed by CPU 71 and a resistance-value calculation program PR3 of the auxiliary battery 30.

RAM 73 stores data generated as CPU 71 operates. RAM 73 has a ring buffer 73A. The ring buffer 73A stores, as time-sequence data of the buffer set STB, time-sequence data of a predetermined period of the second set ST2 which is a combination of the second voltage value V2 and the second current value I2 acquired by the second electronic control unit 70. The buffer set STB is a combination of a voltage value and a current value stored in the ring buffer 73A.

The notification device 80 notifies an abnormality notification indicating an abnormal state. The notification device 80 includes, for example, a display, and can display an image indicating an abnormality notification on the display.

A series of processes involving generation of a first-set ST1 of a first electronic control unit

Next, a series of processes including generation of the first-set ST1 of the first electronic control unit 60 will be described. CPU 61 starts executing the transmission program PRI of the first-set ST1 at a predetermined transmission cycle. The transmission period is, for example, 100 milliseconds.

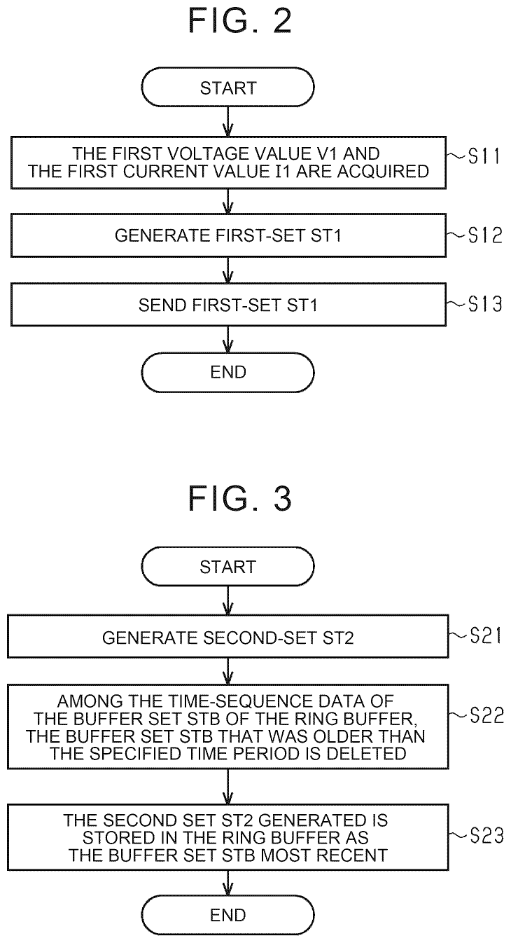

As shown in FIG. 2, when CPU 61 starts executing the transmission program PR1, it first performs a S11 process. In S11, CPU 61 acquires the first voltage-value V1 and the first current-value I1. Specifically, CPU 61 acquires the first voltage value V1 from the first voltage sensor 41. Further, CPU 61 acquires the first current value I1 from the first current sensor 51. Thereafter, CPU 61 advances the process to S12.

In S12, CPU 61 generates a first-set ST1. The first set ST1 is a combination of the first voltage value V1 and the first current value I1. That is, the first voltage value V1 and the first current value I1 included in the first set ST1 are values detected at the same time. Thereafter, CPU 61 advances the process to S13.

In S13, CPU 61 transmits the first-set ST1 to the second electronic control unit 70. Thereafter, CPU 61 ends the series of processes. As described above, when CPU 61 repeats the series of processes in the transmission cycle, CPU 61 transmits the first-set ST1 to the second electronic control unit 70 in the transmission cycle. In the present embodiment, the transmission period is longer than the detection period of the first voltage sensor 41 and the first current sensor 51.

A series of processes involving generation of a second set ST2 of a second electronic control unit

Next, a series of processes including generation of the second-set ST2 of the second electronic control unit 70 will be described. Upon acquiring the second voltage value V2 and the second current value I2, CPU 71 starts executing the storage program PR2 of the buffer set STB. That is, CPU 71 repeatedly executes the storage program PR2 at the detecting cycle of the second voltage sensor 42 and the second current sensor 52.

As illustrated in FIG. 3, when CPU 71 starts executing the storage program PR2 of the buffer set STB, it starts S21 process. In S21, CPU 71 generates a second-set ST2. The second set ST2 is a combination of the second voltage value V2 and the second current value I2. Thereafter, CPU 71 advances the process to S22.

In S22, CPU 71 deletes the buffer set STB that is earlier than the predetermined period among the time-sequence data of the buffer set STB stored in the ring buffer 73A. Thereafter, CPU 71 advances the process to S23. When the buffer set STB of the time-sequence data of the buffer set STB is not stored in the buffer set STB in the past of the specified time period, CPU 71 proceeds to S23 without performing S22 process.

In S23, CPU 71 stores the second set ST2 generated by S21 in the ring buffer 73A as the buffer set STB most recent. Thereafter, CPU 71 ends the series of processes. In this manner, CPU 71 repeats the series of processes to store the time-sequence data of the specified duration of the second set ST2 in the ring buffer 73A as the time-sequence data of the buffer set STB.

Series of processes including the calculation of the resistance value of the auxiliary battery of the second electronic control unit

Next, a series of processes including the calculation of the resistance value of the auxiliary battery 30 of the second electronic control unit 70 will be described. When CPU 71 acquires the first set ST1 as the non-buffer set STN, it starts executing the resistance-value calculation program PR3 of the auxiliary battery 30. In the present embodiment, the first set ST1 is a non-buffer set STN that differs from the second set ST2 that is the buffer set STB.

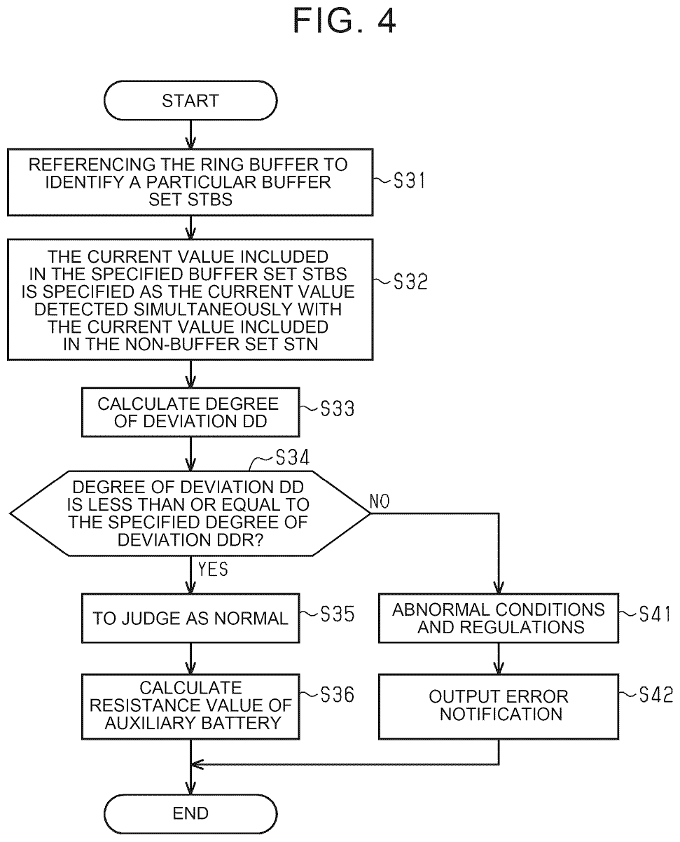

As illustrated in FIG. 4, when CPU 71 starts executing the resistance-value calculation program PR3, it starts S31 process. In S31, CPU 71 refers to the ring buffer 73A to identify a particular buffer set STBS with the same timing as the non-buffer set STN. The particular buffer set STBS is a buffer set STB having a voltage value closest to the voltage value included in the non-buffer set STN among the voltage values included in the time-sequence data of the buffer set STB. Specifically, CPU 71 selects a voltage value closest to the voltage value of the non-buffer set STN from among the voltage values of the plurality of buffer sets STB stored in the ring buffer 73A. Then, CPU 71 identifies the buffer set STB having the nearest selected voltage-value as the specified buffer set STBS. Thereafter, CPU 71 advances the process to S32.

In S32, CPU 71 identifies the current value included in the particular buffer set STBS as the current value detected simultaneously with the current value included in the non-buffer set STN. Thereafter, CPU 71 advances the process to S33.

In S33, CPU 71 calculates a degree of deviation DD between the current value included in the non-buffer set STN and the current value included in the particular buffer set STBS. Specifically, CPU 71 calculates the absolute value of the difference between the current value included in the non-buffer set STN and the current value included in the particular buffer set STBS as the degree of deviation DD. Thereafter, CPU 71 advances the process to S34.

In S34, CPU 71 determines whether or not the degree of deviation DD is equal to or less than a predetermined specified degree of deviation DDR. The specified degree of deviation DDR is determined in advance by tests or simulations as the largest value that deviates when the first current sensor 51 and the second current sensor 52 are in a normal state. When the degree of deviation DD is equal to or smaller than the specified degree of deviation DDR (S34: YES), CPU 71 advances the process to S35.

In S35, CPU 71 determines that the first current sensor 51 and the second current sensor 52 are in a normal condition. Thereafter, CPU 71 advances the process to S36. In S36, CPU 71 calculates the resistivity of the auxiliary battery 30. Specifically, first, CPU 71 sets a current value included in the specified buffer set STBS or a current value included in the non-buffer set STN to a normal current value. Next, CPU 71 sets a current value included in the specified buffer set STBS or a voltage value included in the non-buffer set STN to a normal voltage value. Next, CPU 71 calculates the resistive value of the auxiliary battery 30 based on the normal current value and the normal voltage value. Thereafter, CPU 71 ends the series of processes.

When the degree of deviation DD is larger than the specified degree of deviation DDR (S34: NO), CPU 71 advances the process to S41. In S41, CPU 71 determines that at least one of the first current sensor 51 and the second current sensor 52 is in an abnormal condition. Thereafter, CPU 71 advances the process to S42.

In S42, CPU 71 outputs a request to notify the notification device 80 of the abnormality notification indicating the abnormality status. As a result, the notification device 80 notifies an abnormality notification indicating an abnormal state. Thereafter, CPU 71 ends the series of processes.

### Operations of Embodiment

In the above-described embodiment, the second electronic control unit 70 repeatedly acquires the second set ST2 at the detecting cycle. Thus, the second electronic control unit 70 stores the time-sequence data of the specified duration of the second set ST2 in the ring buffer 73A as the time-sequence data of the buffer set STB. Then, the second electronic control unit 70 receives the first-set ST1 at the transmitting cycle. Accordingly, the second electronic control unit 70 identifies the particular buffer set STBS by comparing the non-buffer set STN and the buffer set STB using the first set ST1 as the non-buffer set STN.

### Effects of Embodiment

(1) According to the above embodiment, the second electronic control unit 70 compares the voltage value included in the specified buffer set STBS and the voltage value included in the non-buffer set STN. Thus, the second electronic control unit 70 can ensure the synchronicity between the current value included in the specified buffer set STBS and the current value included in the non-buffer set STN. Therefore, the in-vehicle system 20 can specify the combination of the first current value I1 and the second current value I2 that ensure the synchronicity, regardless of the comparison between the time information obtained by obtaining the first current value I1 and the time information obtained by obtaining the second current value I2.

(2) According to the above-described embodiment, the second electronic control unit 70 compares the degree of deviation DD between the current value included in the specified buffer set STBS and the current value included in the non-buffer set STN that ensure the synchronicity with the specified degree of deviation DDR. When the degree of deviation DD is larger than the specified degree of deviation DDR, it is determined that at least one of the first current sensor 51 and the second current sensor 52 is in an abnormal condition. Therefore, it is possible to prevent erroneous determination as an abnormal condition on the basis of the degree of deviation DD between the two current values for which the synchronicity is not ensured.

(3) According to the above-described embodiment, when the second electronic control unit 70 determines that an abnormal state is present, the notification device 80 notifies the abnormality notification. Thus, for example, by notifying the user of the vehicle 10 of the abnormal state, it is possible to urge the dealer to take a measure for eliminating the abnormal state, such as transporting the vehicle 10.

(4) According to the above-described embodiment, after determining that the state is normal, the second electronic control unit 70 sets the current value included in the specified buffer set STBS or the current value included in the non-buffer set STN to the normal current value. Further, the second electronic control unit 70 sets the voltage value included in the specified buffer set STBS or the voltage value included in the non-buffer set STN to the normal voltage value. The second electronic control unit 70 calculates the resistance value of the auxiliary battery 30 based on the normal current value and the normal voltage value. As described above, according to the above-described embodiment, the second electronic control unit 70 can calculate the resistance value of the auxiliary battery 30 using the current value and the voltage value determined to be in the normal state by using the two sets in which the synchronicity is ensured. Therefore, the second electronic control unit 70 can prevent the resistance value of the auxiliary battery 30 from being erroneously calculated by using the set of the current value and the voltage value that do not ensure the synchronicity.

(5) In the above-described embodiment, the time-sequence data of the buffer set STB is time-sequence data of a prescribed duration of the second set ST2. The detection period, which is a period in which the second electronic control unit 70 acquires the second set ST2, is longer than the transmission period, which is a period in which the second electronic control unit 70 receives the first set ST1 from the first electronic control unit 60. That is, according to the above-described embodiment, among the first set ST1 and the second set ST2, the second set ST2 having a short period acquired by the second electronic control unit 70 is set as the buffer set STB. Therefore, the time-sequence data of the buffer set STB is likely to include the data detected at the same time as the non-buffer set STN.

### Other Embodiments

The present embodiment can be realized with the following modifications. The present embodiment and the following modifications can be combined with each other within a technically consistent range to be realized.
The second electronic control unit 70 may not calculate the resistance value of the auxiliary battery 30. That is, the second electronic control unit 70 may omit S36 process. In this instance, another device, such as the notification device 80, may perform S36 process.
The second electronic control unit 70 may not output the abnormality notification. That is, the second electronic control unit 70 may omit S42 process. In this instance, another device, such as the notification device 80, may perform S42 process.
The second electronic control unit 70 may not calculate the degree of deviation DD. In addition, the second electronic control unit 70 may not determine that an abnormal state is present. That is, the second electronic control unit 70 may omit the processes of S34, S35 and S41. In this instance, other devices, such as the notification device 80, may perform S34, S35, and S41 processes.
The first set ST1 may be set to the buffer set STB, and the second set ST2 may be set to the non-buffer set STN. Even in this case, the second electronic control unit 70 can specify the combination of the current value of the first set ST1 and the current value of the second set ST2 that ensure the synchronicity by comparing the voltage value of the first set ST1 with the voltage value of the second set ST2.
The degree of deviation DD is not limited to the absolute value of the difference between the current value included in the particular buffer set STBS and the current value included in the non-buffer set STN. For example, the degree of deviation DD may be a value obtained by dividing the current value included in the particular buffer set STBS by the current value included in the non-buffer set STN.

What is claimed is:

1. An in-vehicle system, comprising:
an auxiliary battery that supplies electric power to auxiliary equipment of a vehicle,
a first voltage sensor that detects a voltage value of the auxiliary battery as a first voltage value;
a first current sensor that detects a current value of the auxiliary battery, when detecting the first voltage value, as a first current value;
a second voltage sensor that detects a voltage value of the auxiliary battery as a second voltage value;
a second current sensor that detects a current value of the auxiliary battery, when detecting the second voltage value, as a second current value;
a first electronic control unit that acquires the first voltage value from the first voltage sensor, and also acquires the first current value from the first current sensor; and
a second electronic control unit that includes a ring buffer, and that acquires the second voltage value from the second voltage sensor, and also acquires the second current value from the second current sensor, wherein
the first electronic control unit executes transmitting of the first voltage value and the first current value to the second electronic control unit, and
the second electronic control unit executes
receiving the first voltage value and the first current value from the first electronic control unit,
storing, in the ring buffer, time-sequence data of a stipulated period set in advance, of one of a first set that is a combination of the first voltage value and the first current value and a second set that is a combination of the second voltage value and the second current value, as time-sequence data of a buffer set, and
identifying a current value included in the buffer set with a voltage value nearest to a voltage value included in a non-buffer set that is a set differing from the buffer set out of the first set and the second set, of the voltage values included in the time-sequence data in the buffer set, as a current value detected at the same time as the current value included in the non-buffer set.

2. The in-vehicle system according to claim 1, wherein the second electronic control unit further executes
calculating a degree of deviation between the current value included in the buffer set that is identified and the current value included in the non-buffer set,
determining whether the degree of deviation that is calculated is greater than a stipulated degree of deviation that is set in advance, and
determining, when the degree of deviation is greater than the stipulated degree of deviation, that at least one of the first current sensor and the second current sensor is in an abnormal state.

3. The in-vehicle system according to claim 2, further comprising a notification device that performs notification of an abnormality notification indicating the abnormal state, wherein the second electronic control unit further executes outputting of the abnormality notification from the notification device when the degree of deviation is greater than the stipulated degree of deviation.

4. The in-vehicle system according to claim 2, wherein, when the degree of deviation is no greater than the stipulated degree of deviation, the second electronic control unit calculates a resistance value of the auxiliary battery, based on a current value included in the buffer set that is identified or a normal current value that is a current value included in the non-buffer set, and a current value included in the buffer set that is identified or a normal voltage value that is a voltage value included in the non-buffer set.

5. The in-vehicle system according to claim 1, wherein:
the time-sequence data of the buffer set is time-sequence data of the stipulated period of the second set; and
a cycle at which the second electronic control unit acquires the second set is longer than a cycle at which the second electronic control unit receives the first set from the first electronic control unit.
